(19) United States
(12) Patent Application Publication
(10) Pub. No.: US 2010/0150499 A1
(43) Pub. Date: Jun. 17, 2010

(54) PHOTONICS DEVICE HAVING ARRAYED WAVEGUIDE GRATING STRUCTURES

(75) Inventors: Duk-Jun Kim, Daejeon (KR); Jung-Hyung Pyo, Seoul (KR); Jung-Ho Song, Daejeon (KR); In-Gyoo Kim, Daejeon (KR); Gyung-Ock Kim, Seoul (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/477,907

(22) Filed: Jun. 4, 2009

(30) Foreign Application Priority Data
Dec. 17, 2008 (KR) 10-2008-0128611

(51) Int. Cl. G02B 6/34; G02B 6/26

(52) U.S. Cl. 385/37; 385/46

(57) ABSTRACT

Provided is a photonics device including at least two arrayed waveguide grating structures. Each of the arrayed waveguide grating structures of the photonics device includes an input star coupler, an output star coupler, and a plurality of arrayed waveguides optically connecting the input star coupler to the output star coupler. Each of the arrayed waveguides includes at least one first section having a high confinement factor and at least two second sections having a low confinement factor. The first sections of the arrayed waveguides have the same structure.

### CROSS-REFERENCE TO RELATED APPLICATIONS

This U.S. non-provisional patent application claims priority under 35 U.S.C. §119 of Korean Patent Application No. 10-2008-00128611, filed on Dec. 17, 2008, the entire contents of which are hereby incorporated by reference.

### BACKGROUND OF THE INVENTION

The present invention disclosed herein relates to a photonics device.

Wavelength division multiplexing (WDM) optical interconnection technologies may be used to realize a high speed bus of a semiconductor device such as a central processing unit (CPU). At this point, to exchange signals through the optical interconnection technologies, a technology for splitting optical signals according to their wavelengths is required. An arrayed waveguide grating (AWG) is a wavelength division device for the above purpose and has various advantages such as high efficiency, simple mass production, and inexpensive packaging costs. Especially, the wavelength division device such as the AWG is required in order to realize an optical device in which a multi-wavelength laser or a multi-channel optical modulation and an optical detection device are integrated.

FIG. 1 is a plan view of a typical AWG.

Referring to FIG. 1, an AWG includes an input star coupler 2 disposed between an input waveguide 1 and an output waveguides 5, an arrayed waveguide structure, and an output star coupler 4. The arrayed waveguide structure includes arrayed waveguides 3 having lengths different from each other and optically connecting the input and output star couplers 2 and 4.

The input star coupler 2 splits optical signals incident from the input waveguide 1 into each of arrayed waveguides 3 of the arrayed waveguide structure. At this point, since the arrayed waveguide structure can serve as a diffraction grating due to the length difference between the arrayed waveguides 3, the optical signals outputted from the arrayed waveguides 3 are focused on positions different from each other according to their wavelengths. Since the output waveguides 5 are connected to the output star coupler 4 at the positions at which the optical signals are focused, the optical signals are split (i.e., demultiplexed) into the respective output waveguides 5 according to their wavelengths. On the other hand, in case where optical signals having respective proper wavelengths are incident into the output waveguides 5, the wavelength-multiplexed optical signals are outputted from the input waveguide 1. That is, the AWG may be used for wavelength-multiplexing and wavelength-demultiplexing. Detailed descriptions of an operation principle, design, and application of the AWG are disclosed in a paper (“PHASR-Based WDM-Devices: Principles, Design and Applications,” IEEE Journal of Selected Topics in Quantum Electronics, Vol. 2, No. 2, pp. 236-250 (1996)) published by M. K. Smit et al.

### SUMMARY OF THE INVENTION

The present invention provides a photonics device including arrayed waveguide grating structures in which a difference between center wavelengths is reduced.

The present invention also provides an optical transmitter including arrayed waveguide grating structures in which a difference between center wavelengths is reduced.

The present invention also provides an optical transceiver including arrayed waveguide grating structures in which a difference between center wavelengths is reduced.

Embodiments of the present invention provide photonics devices including at least two arrayed waveguide grating structures. Each of the arrayed waveguide grating structures of the photonics devices includes an input star coupler, an output star coupler, and a plurality of arrayed waveguides optically connecting the input star coupler to the output star coupler. At this time, each of the arrayed waveguides includes at least one first section having a high confinement factor and at least two second sections having a low confinement factor, and the first sections of the arrayed waveguides have the same structure.

In some embodiments, the arrayed waveguide grating structures may include a first arrayed waveguide grating structure used as a wavelength division demultiplexing device and a second arrayed waveguide grating structure used as a wavelength division multiplexing device, and thus, the first and second arrayed waveguide grating structures may constitute an optical transmitter in a wavelength division multiplexing scheme. In this case, each of the photonics devices may further include first waveguides connecting the first arrayed waveguide grating structure to the second arrayed waveguide grating structure and optical modulators respectively disposed on the first waveguides.

In other embodiments, the arrayed waveguide grating structures may further include a third arrayed waveguide grating structure. In this case, each of the photonics devices may further include a plurality of photo detectors converting optical signals outputted from the third arrayed waveguide grating structure into electrical signals. The third arrayed waveguide grating structure may split incident optical signals into the photo detectors according to their wavelengths.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a plan view of a typical arrayed waveguide grating;

FIG. 2 is a plan view of an arrayed waveguide grating according to an embodiment of the present invention;

FIG. 3 is a perspective view illustrating a portion of an arrayed waveguide grating according to an embodiment of the present invention;

FIG. 4 is a graph illustrating results obtained by simulating an effective index change of a waveguide according to a width of a core pattern and a thickness difference between the core pattern and an auxiliary pattern;

FIGS. 5A to 5D are graphs illustrating results obtained by simulating waveguide mode distribution of TE polarized optical signals according to a thickness of an auxiliary pattern;

FIG. 6 is a perspective view illustrating a portion of an arrayed waveguide grating according to another embodiment of the present invention;

FIG. 7 is a plan view illustrating a portion of an approximately linear section according to an embodiment of the present invention;

FIGS. 8A and 8B are plan views illustrating structures of array waveguides according to another embodiment of the present invention;

FIGS. 9 and 10 are views of photonics devices including arrayed waveguides;

FIG. 11 is a view illustrating positions of photonics devices integrated on an 5-inch silicon wafer;

FIGS. 12 and 13 are cross-sectional views illustrating waveguide structures of an arrayed waveguide structure constituting photonics devices;

FIG. 14 is a graph illustrating deviation characteristics of center wavelengths in a photonics device according to the present invention; and

FIG. 15 is a table illustrating deviation characteristics of center wavelengths in photonics devices according to the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the specification, the dimensions of layers and regions are exaggerated for clarity of illustration. It will also be understood that when a layer (or film) is referred to as being ‘on’ another layer or substrate, it can be directly on the other layer or substrate, or intervening layers may also be present. Also, though terms like a first, a second, and a third are used to describe various regions and layers in various embodiments of the present invention, the regions and the layers are not limited to these terms. These terms are used only to tell one region or layer from another region or layer. Therefore, a layer referred to as a first layer in one embodiment can be referred to as a second layer in another embodiment. An embodiment described and exemplified herein includes a complementary embodiment thereof.

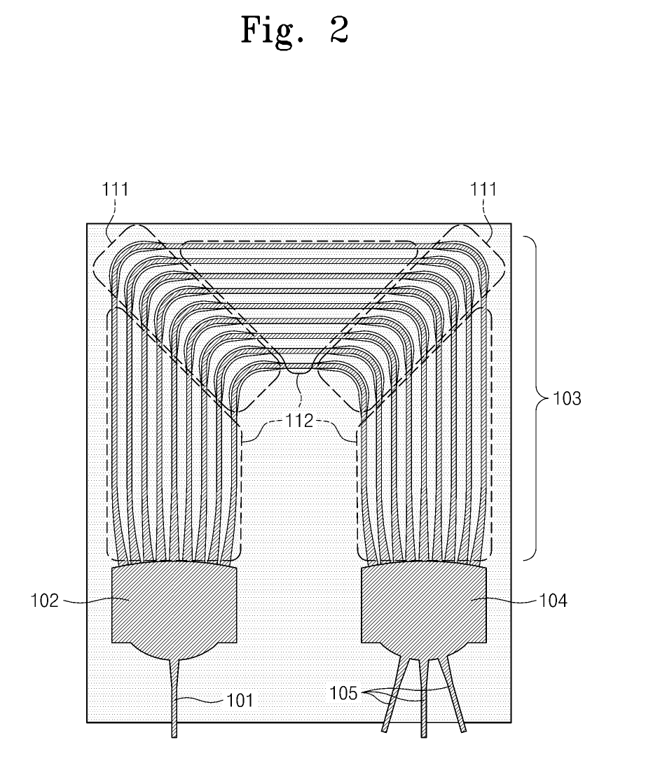

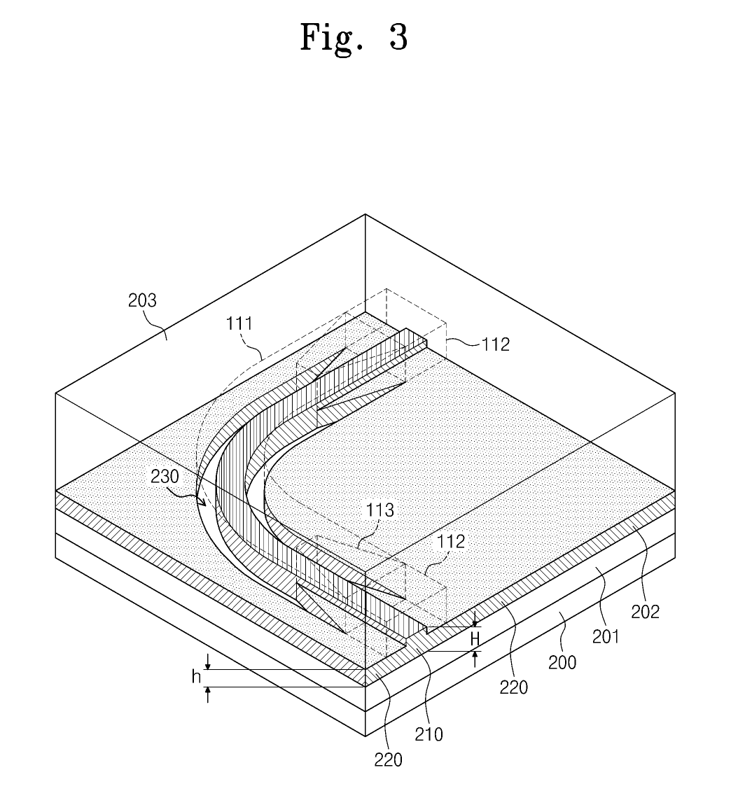

FIG. 2 is a plan view of an arrayed waveguide grating according to an embodiment of the present invention, and FIG. 3 is a perspective view illustrating a portion of an arrayed waveguide grating according to an embodiment of the present invention.

Referring to FIGS. 2 and 3, an arrayed waveguide grating (AWG) according to the present invention includes a substrate 200, a lower clad 210, a core layer 202, and an upper clad 203 that are sequentially stacked. The core layer is patterned to form at least one input waveguide 101, an input star coupler 102, a plurality of arrayed waveguides 103, an output star coupler 104, and a plurality of output waveguides 105.

According to an embodiment, the substrate 200 may include a silicon substrate, and the core layer 202 may be formed of silicon, silicon nitride, or indium phosphide (InP). The lower and upper clads 201 and 203 may be formed of one of materials having a refractive index less than that of the core layer 202. For example, the lower and upper clads 201 and 203 may include a silicon oxide layer. However, a person of ordinary skill in the art can realize the technical idea of the present invention based on materials that are not explained herein as an example. That is, the technical idea of the present invention is not limited to the exemplified materials, and the prevent invention can be realized based on various materials that are well-known in this field.

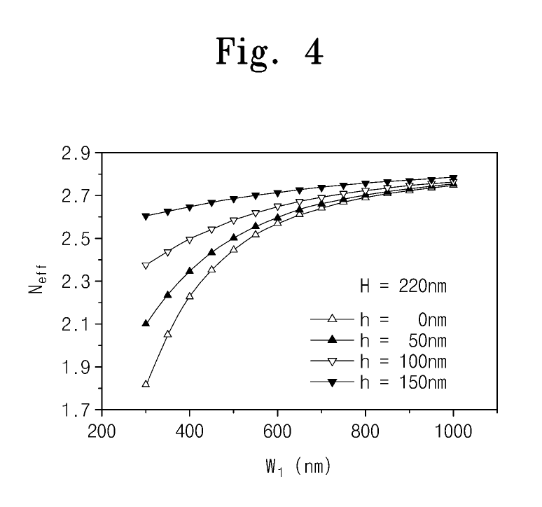

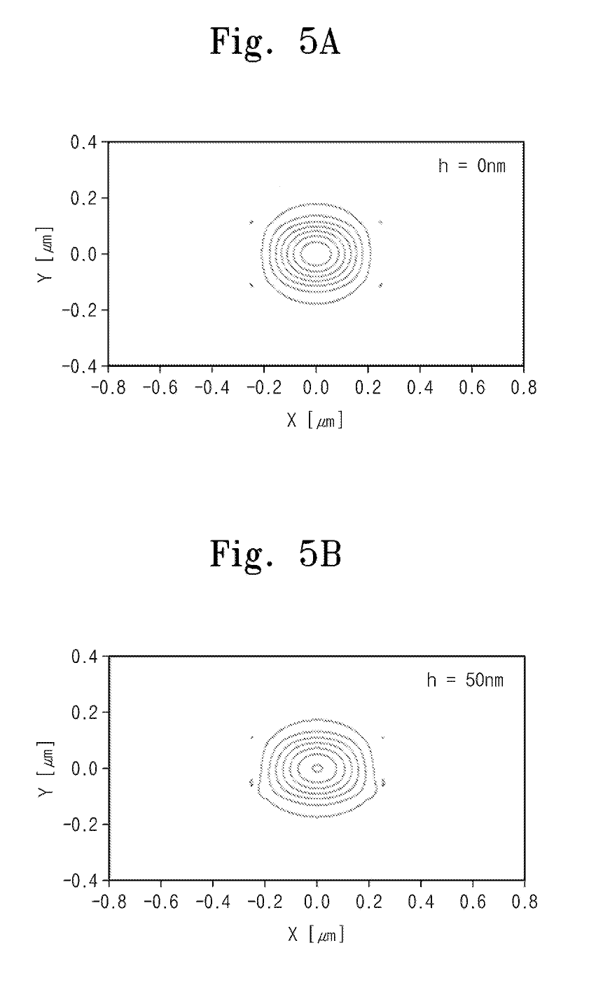

The arrayed waveguides 103 may include a first section having a high confinement factor and a second section having a low confinement factor, respectively. Specifically, according to an embodiment of the present invention, each of the arrayed waveguides 103 may include at least two approximately linear sections 112 and at least one bending section 111 disposed between the approximately linear sections 112. According to an embodiment, the approximately linear sections 112 may be the second section having the low confinement factor, and the bending section 111 may be the first section having the high confinement factor. A specific method for realizing such a difference of the confinement factors and a technical effect resulting from the method will be described again with reference to FIGS. 4 and 5A to 5D.

In this embodiment, each of the arrayed waveguides 103 may include two bending sections 111 as shown in FIG. 2. At this time, all of the bending sections 111 corresponding to each of the arrayed waveguides 103 may have the same structure. That is, the bending sections 111 corresponding to each of the arrayed waveguides 103 have the substantially same length, thickness, width, curvature, and material. However, according to another embodiment of the present invention, within a range that does not have an effect on phases of optical signals, the bending sections 111 corresponding to each of the arrayed waveguides 103 may have at least different one of the length, the thickness, the width, the curvature, and the material.

Similarly, the two bending sections 111 formed within one arrayed waveguide 103 may have the same structure. However, according to another embodiment of the present invention, the two bending sections 111 formed within one arrayed waveguide 103 may have structures different from each other. In spite of that, as described above, the bending sections 111 corresponding to the respective arrayed waveguides 103 may have the substantially same structure.

According to this embodiment, the bending sections 111 may optically connected to the input/output star couplers 102 and 104 by the three approximately linear sections 112 connecting the bending sections 111 to each other in series. At this time, the approximately linear sections 112 of each of the arrayed waveguides 103 have lengths different from each other, unlike the bending sections 111. In this case, as described above, since the bending sections 111 corresponding to each of the arrayed waveguides 103 have the substantially same structure, an optical path length difference in the arrayed waveguides 103 is determined by the approximately linear sections 112. Since such a length difference in the approximately linear sections 112 generates an optical path length difference of the optical signals, the optical signals outputted from the arrayed waveguides 103 are focused on positions different from each other according to their wavelengths. Thus, the arrayed waveguides 103 may serve as a diffraction grating.

It will be understood by those skilled in the art that a method capable of implementing the number, structures, and arrangements of the bending sections 111 and the approximately linear sections 112 may be varied therein without departing from the spirit and scope of the invention as defined by the appended claims.

FIG. 3 illustrates one method for implementing a confinement factor difference of an arrayed waveguide. Again referring to FIG. 3, according to this embodiment, the core layer 202 may include a core pattern 210 and an auxiliary pattern 220 having a thickness thinner than that of the core pattern 210. In this case, a waveguide mode of an optical signal is mainly distributed within the core pattern 210 and proceeds along the core pattern 210. That is, a waveguide path of the optical signal is substantially guided by the core pattern 2 10.

The auxiliary pattern 220 may be formed of the same material as the core pattern 210. The auxiliary pattern 220 may extend from the core pattern 210 to cover a portion of a lower sidewall of the core pattern 210. More specifically, the auxiliary pattern 220 may cover the lower sidewall of the core pattern 210 around the approximately linear sections 112 and may be spaced from the core pattern 210 in the bending section 111. As a result, an opening 230 defined by the core pattern 210 and the auxiliary pattern 220 and exposing the lower clad 201 may be defined in the bending section 111.

Thus, the whole sidewalls of the core pattern 210 are in contact with the upper clad 203 in the bending section 111. On the other hand, the sidewalls of the core pattern 210 are in contact with all of the upper clad 203 and the auxiliary pattern 220 in the approximately linear sections 112. At this time, as described above, the auxiliary pattern 220 and the upper clad 203 are formed of material different from each other. Such a refractive index difference and a difference of an area contacting with the core pattern 210 may be used for a method for reducing an effective refractive index change and a phase error of the waveguide as described below with reference to FIG. 4.

FIG. 4 is a graph illustrating results obtained by simulating an effective index change of a waveguide according to a width of the core pattern 210 and a thickness difference between the core pattern 210 and the auxiliary pattern 220. More specifically, it was assumed that a thickness H of the core pattern 210 is about 220 nm, and the optical signal is TE-polarized. Under this conditions, an effective refractive index N_{eff} was calculated while a width W₁ of the core pattern and a thickness h of the auxiliary pattern are changed.

Referring to FIG. 4, as the width W₁ of the core pattern decreases, a change rate (i.e., dN_{eff}/dW₁) of the effective refractive index N_{eff} with respect to a width change Δ W1 of the core pattern increased regardless of the thickness h of the auxiliary pattern. Particularly, the change rate dN_{eff}/dW₁ of the effective refractive index N_{eff} significantly increased in case where the thickness h of the auxiliary pattern is zero, and the width W₁ of the core pattern is less than about 500 nm. However, as the thickness h of the auxiliary pattern increases, the change rate dN_{eff}/dW₁ of the effective refractive index N_{eff} decreased.

The phase error of the arrayed waveguide is sensitive to an effective refractive index change Δ N_{eff}, and a crosstalk of the AWG is sensitive to the phase error of the arrayed waveguide. Thus, to improve the crosstalk of the AWG or the phase error of the arrayed waveguide, it is required to manufacture the arrayed waveguide 103 having a low change rate dN_{eff}/dW₁ of the effective refractive index N_{eff}.

According the simulation results of FIG. 4, such a technological requirement can be satisfied through a method in which a difference between the thickness h of the auxiliary pattern and the thickness H of the core pattern is reduced. For this reason, the thickness h of the auxiliary pattern 220 may range from about 40% to about 85% of the thickness T of the core pattern 210 in a region adjacent to the core pattern 210. However, the auxiliary pattern 220 may have the substantially same thickness as the core pattern 210 at a position spaced from the core pattern 210. When considering this fact, the thickness h of the auxiliary 220 may range from about 40% to about 100% of the thickness T of the core pattern 210.

FIGS. 5A to 5D are graphs illustrating results obtained by simulating waveguide mode distribution of TE polarized optical signals according to a thickness of an auxiliary pattern. Specifically, in this simulation, it was assumed that a thickness and a width of the core pattern 210 are about 220 nm and about 500 nm, respectively, and FIGS. 5A to 5D illustrate simulation results in case where the thicknesses h of the auxiliary pattern 220 are 0 nm, 50 nm, 100 nm, and 150 nm, respectively.

Referring to FIGS. 5A to 5D, as the thickness h of the auxiliary pattern increases, a distribution of the waveguide mode was widen in a side direction (an x-direction of each of the graphs). That is, as the thickness h of the auxiliary pattern increases, the waveguide had a reduced confinement factor. This is done because the auxiliary pattern 220 has the same material as the core pattern 210, and thus, the auxiliary pattern 220 does not have a significant effect on a lateral confinement factor of the waveguide mode. Thus, a center of the waveguide mode of the optical signal is positioned within the core pattern 210, and the thickness difference between the core pattern 210 and the auxiliary pattern determines a rate (i.e., confinement factor) at which the waveguide mode of the optical signal is distributed within the core pattern 210.

When the confinement factor decreases, optical coupling efficiency between the input and output star couplers 102 and 104 and the arrayed waveguides 103 increases. Thus, it is required that the arrayed waveguide 103 has a low confinement factor in a region in which the arrayed waveguide 103 is connected to the input and output star couplers 102 and 104. When considering simulation results of FIGS. 5A to 5D, the low confinement factor can be achieved through a method in which the thickness h of the auxiliary pattern increases. However, when the thickness h of the auxiliary pattern is equal to the thickness H of the core pattern 210, it is difficult to guide the waveguide path of the optical signal. Thus, the auxiliary pattern 220 may have a thickness thinner than that of the core pattern 210.

However, in case of the low confinement factor, a high optical loss may occur in the waveguide having a small curvature radius (e.g., the bending section 111). For example, since the waveguide mode is broadly distributed in the side direction as the thickness h of the auxiliary pattern increases, energy of the optical signal may be lost in the bending section 111. At this time, a method for increasing a curvature radius may be used as a method for reducing an intensity loss of the optical signal. However, such a method has another limitation that the AWG significantly increases in size. On the other hand, as proposed through the present invent, in case where the auxiliary pattern 220 is spaced from the core pattern 210 in the bending section 111, since the core pattern 210 is covered by the upper clad 203 having the low refractive index, the high confinement factor can be obtained as described above. In case where the arrayed waveguide 103 has the high confinement factor in the bending section 111, the bending section 111 may have the small curvature radius, and the intensity loss of the optical signal proceeding into the bending section 111 may be minimized.

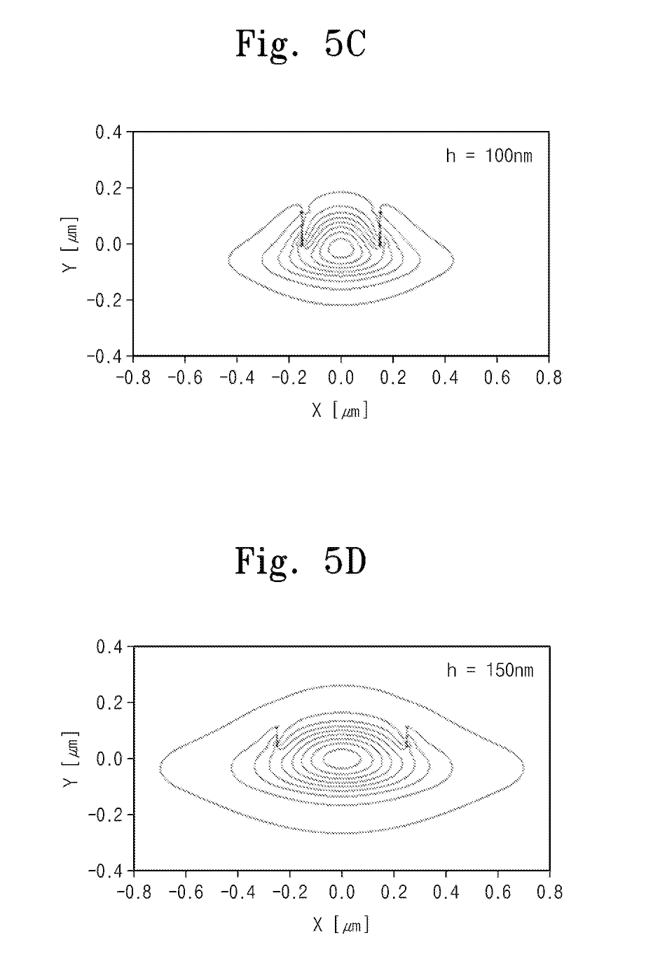

FIG. 6 is a perspective view illustrating a portion of an arrayed waveguide grating according to another embodiment of the present invention. In this embodiment, a core pattern of an arrayed waveguide for generating a difference of a confinement factor may be formed of materials different from each other in a bending section 111 and an approximately linear section 112. Since a waveguide according to this embodiment has the same structure as the aforementioned waveguide except the above-described differences, the duplicated explanations will be omitted for simple description.

Referring to FIG. 6, according to this embodiment, a core layer of an arrayed waveguide 103 may be formed of two materials having refractive indexes different from each other. Specifically, the arrayed waveguide 103 include a high refractive index pattern 211 and a low refractive index pattern 212. The high refractive index pattern 211 is used as the core layer in the bending section 111. The low refractive index pattern 212 has a refractive index lower than that of the high refractive index pattern 211 and is used as the core layer in the approximately linear section 112. At this time, an upper clad 203 may cover a top surface and sidewalls of the high refractive index pattern 211 in the bending section 111. As a result, the upper clad 203 and the low refractive index pattern 212 are used as the clad layer in the approximately linear section 112 and the bending section 111, respectively.

The low refractive index pattern 212 may be formed of a material having a refractive index greater than that of the upper clad 203. For example, the low refractive index pattern 212 may include a silicon nitride layer, and the upper clad 203 may include a silicon oxide layer. In addition, according to the present invention, a refractive index difference Δ N1 between the low refractive index pattern 212 and the high refractive index pattern 211 may greater than a refractive index difference Δ N2 between the upper clad 203 and the low refractive index pattern 212 (Δ N1>Δ N2).

The refractive index difference can satisfies technical ideas of the aforementioned present invention. Specifically, in case of Δ N1>Δ N2, since a confinement factor in the bending section is greater than that in the approximately linear section, the bending section 111 may have a small curvature radius, and an intensity loss of an optical signal proceeding into the bending section 111 may be minimized.

According to this embodiment, a transition region for a movement of a waveguide mode between the high refractive index pattern 211 and the low refractive index pattern 212 may be formed within the approximately linear section 112 (i.e., a section having the low confinement factor). In this transition region, the high refractive index pattern 211 becomes narrow in width toward the approximately linear section 112. That is, both ends of the high refractive index pattern 211 may have tapered shapes as shown in FIG. 6, respectively. However, the method for the movement of the waveguide mode may be variously modified. Thus, the present invention is not limited to the exemplified method.

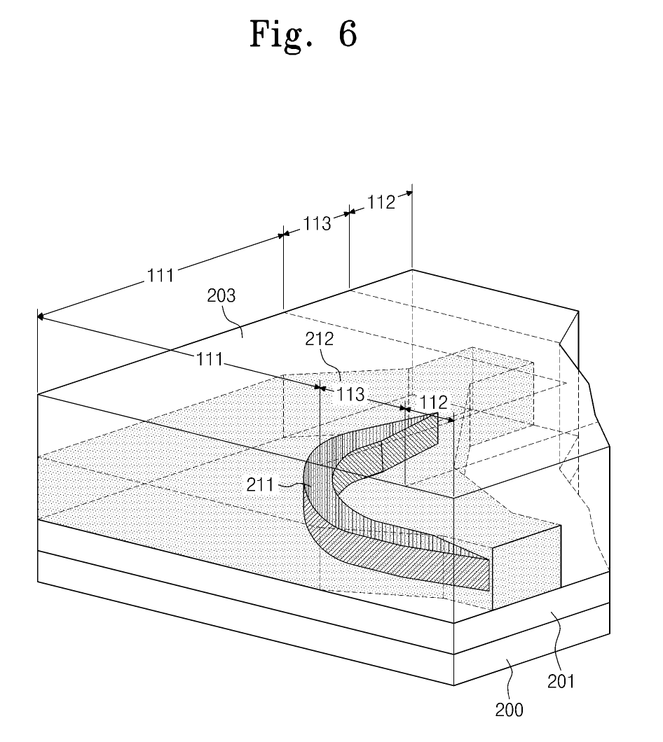

FIG. 7 is a plan view illustrating a portion of an approximately linear section according to an embodiment of the present invention.

Referring to FIG. 7, the approximately linear section 112 of the arrayed waveguides 103 may include linear sections 103a and smoothly curved sections 103b. Each of the core layers of the arrayed waveguides 103 has an infinite curvature radius in the linear sections 103a and has a large curvature radius in the smoothly curved sections 103b than in the bending sections 111. According to this embodiment, the arrayed waveguides 103 may have the same curvature radius in the smoothly curved sections 103b regardless of positions thoseof and different lengths according to the positions thoseof (L1>L2>L3>L4).

It is difficult to calculate a phase change of the optical signal according to the curvature radius change of the arrayed waveguides 103. Thus, in case where curvature radii of the arrayed waveguides 103 are different from each other according to the respective arrayed waveguides, it is difficult to control the phase change of the optical signal. However, as described above, in case where the arrayed waveguides 103 have the same curvature radius in the smoothly curved sections 103b, the phase change of the optical signal may independent to the curvature radius in the smoothly curved sections 103b, and thus, the phase change of the optical signal may be easily controlled by the lengths of the smoothly curved sections 103b.

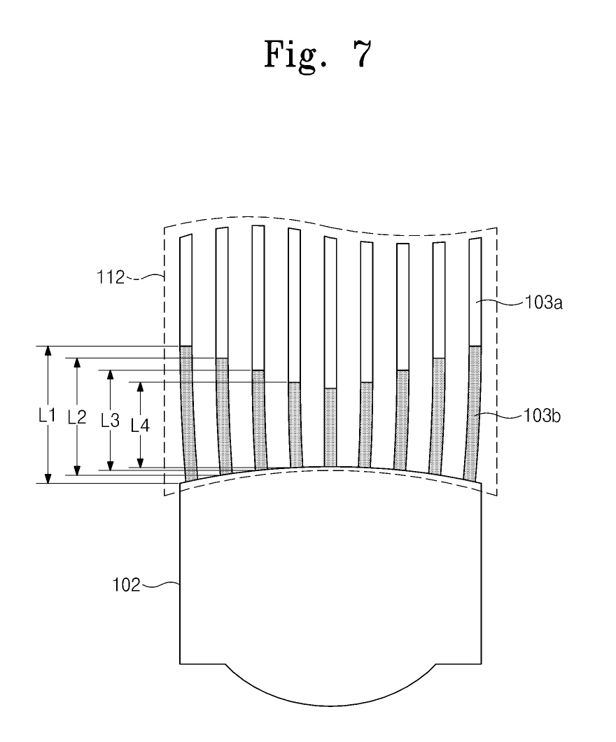

FIGS. 8A and 8B are plan views illustrating structures of an array waveguides according to another embodiment of the present invention. Specifically, FIGS. 8A and 8B are modified examples of the embodiments described with reference to FIGS. 3 and 6, respectively. Also, these embodiments are similar to the aforementioned embodiments except that the approximately linear section 112 further includes sections 114 having a high confinement factor. Thus, the duplicated explanations will be omitted for simple description.

Referring to FIGS. 8A and 8B, each of approximately linear sections 112 may further include a transition section 113 for a movement of a waveguide mode. A structure of the transition section 113 may variously modified based on well-known technologies.

In addition, at least one or more of the approximately linear sections 112 may further include sections 114 having a high confinement factor. The respective sections 114 having the high confinement factor can finely adjust a phase of an optical signal proceeding into a waveguide. For this, the sections 114 may have structures different from each other (e.g., lengths different from each other) in each of the arrayed waveguides 103.

According to this embodiment, the respective sections 114 having the high confinement factor may be disposed between a bending section 111 and a transition section 113. However, the section 114 having the high confinement factor may be defined in a predetermined region on the approximately linear section 112. For example, the section having the high confinement factor may be defined between the transition section 113 and input/output star couplers 102 and 104.

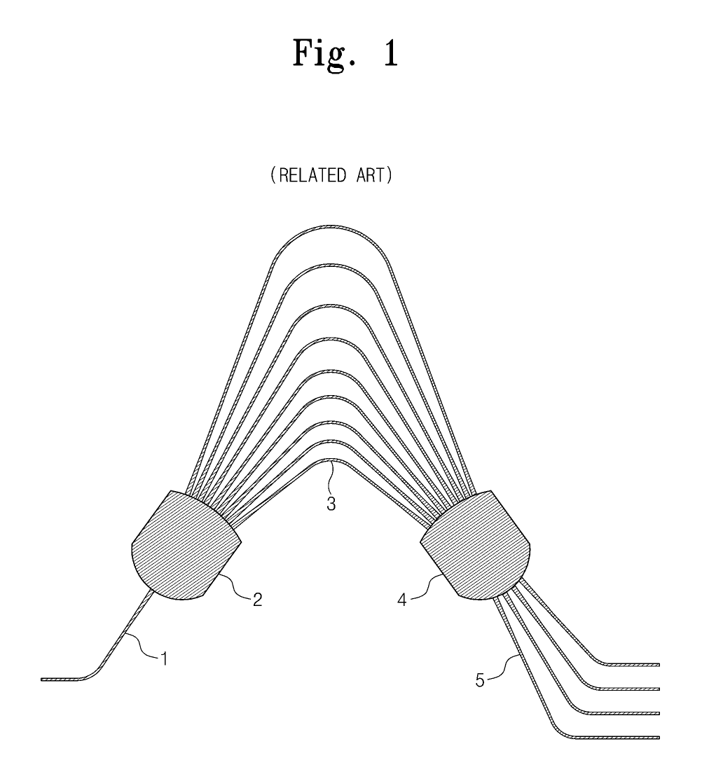

In order to exchange an optical signal between photonics devices or within each of the photonics devices in a WDM scheme, a wavelength multiplexing device and a wavelength demultiplexing device must be integrated together within the photonics device. Thus, to manufacture a WDM optical transceiver using the AWG as shown in FIG. 1, at least two AWGs are required, and also, it is required that output waveguides 5 corresponding to the AWGs have wavelengths corresponding to designed values, respectively. However, since a process deviation (particularly, a deviation in an etching process) in a process for manufacturing the AWGs, center wavelengths of the AWGs may be different from each other even within the same photonics device. (At this time, the center wavelengths denote wavelengths of light emitted through a middle waveguide of the waveguides.)

More specifically, a center wavelength λ_{c} in each of the AWGs can be represented by following formula:

λ_{c}=(N_{eff}Δ L)/m (1)

(where, N_{eff} is an effective index of a fundamental mode with respect to the arrayed waveguide, and Δ L is a physical length between arrayed waveguides adjacent to each other. Thus, multiply N_{eff} by Δ L is an optical path length difference between the arrayed waveguides adjacent to each other. In addition, m is a diffraction order which is an integer number.)

Thus, to design the AWGs, N_{eff} is calculated based on a material and a structure of a waveguide to be used in an actual AWG manufacturing process, and then, it is required to select Δ L and m satisfying a specific λ_{c}. However, since the effective index N_{eff} of the arrayed waveguide is imperfect in the etching process as described above, the effective index N_{eff} of the arrayed waveguide may be different according to positions of the AWGs. As a result, the center wavelength λ_{c} of each of the AWGs may be different also according to the positions of the AWGs.

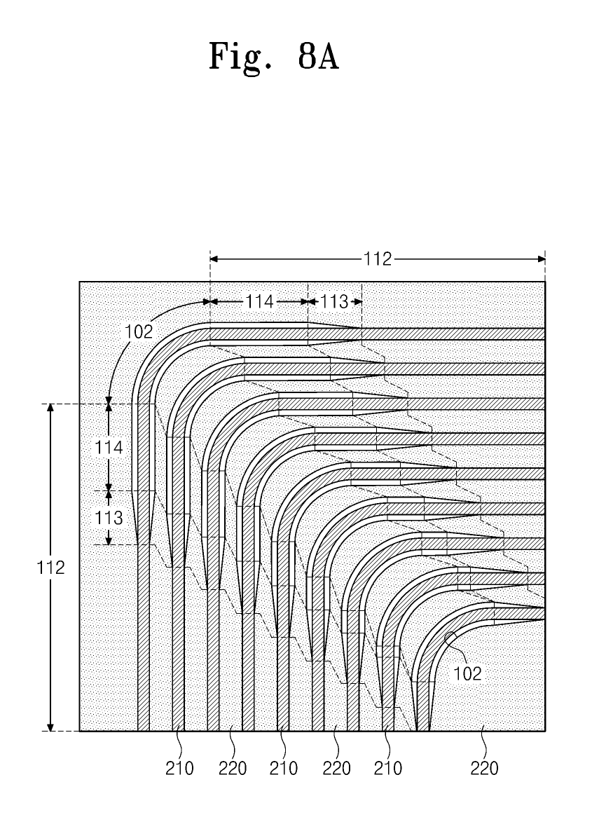

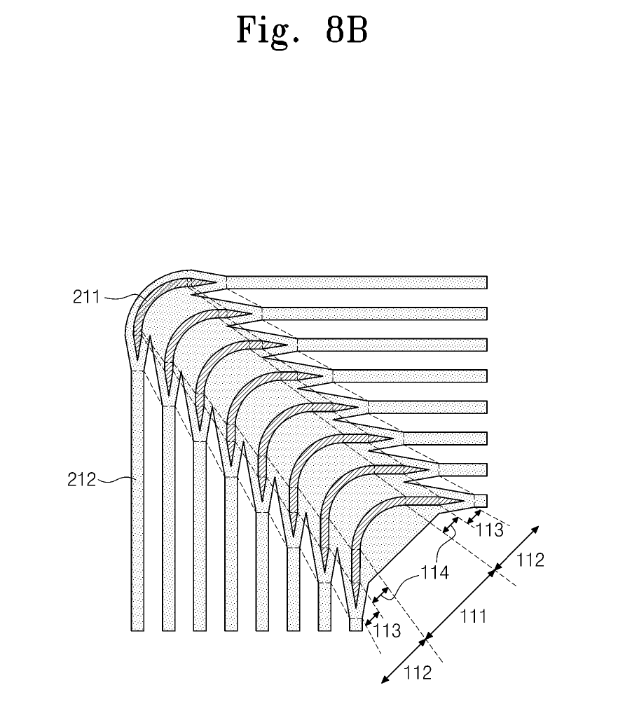

FIGS. 9 and 10 are views of photonics devices including arrayed waveguides.

Referring to FIG. 9, a photonics device 10 according to this embodiment includes first and second waveguides 3 1 and 33 for communicating with an external devices and first and second arrayed waveguide grating structures AWG1 and AWG2 disposed between the first and second waveguides 31 and 33.

The first arrayed waveguide grating structure AWG1 may be used for demultiplexing, and the second arrayed waveguide grating structure AWG2 may be used for multiplexing. At this time, optical signals demultiplexed by the first arrayed waveguide grating structure AWG1 are multiplexed by the second arrayed waveguide grating structure AWG2 and transmitted to the external devices through the second waveguide 33. For this, a plurality of connection waveguides 32 is disposed between the first and second arrayed waveguide grating structures AWG1 and AWG2. The plurality of connection waveguides 32 optically connects the first and second arrayed waveguide grating structures AWG1 and AWG2 to each other.

In addition, the connection waveguides 32 may pass through optical modulators M1, M2, and M3 for modulating the demultiplexed optical signals λ₁, λ₂, and λ₃. As a result, the optical signals λ₁, λ₂, and λ₃ incident through the first waveguide 31 are split by the first arrayed waveguide grating structure AWG1 according to their wavelengths, modulated by the optical signals λ₁, λ₂, and λ₃, and transmitted to the external devices via the second arrayed waveguide grating structure AWG2. Thus, the photonics device 10 according to this embodiment may be used as a WDM optical transmitter.

Referring to FIG. 10, the photonics device 10 according to this embodiment may be used as a WDM optical transceiver. More specifically, the photonics device 10 according to this embodiment may further include an optical receiver as well as the optical transmitter described with reference to FIG. 9.

The optical receiver may include a fourth waveguide 34 used as the input waveguide, a third arrayed waveguide grating structure AWG3 connected to the fourth waveguide 34, a plurality of photo detectors D1, D2, and D3, and a fifth waveguides 35 connecting the third arrayed waveguide grating structure AWG3 to each of the photo detectors D1, D2, and D3.

The third arrayed waveguide grating structure AWG3 may be used for demultiplexing that splits optical signals according to their wavelengths. The split optical signals may be converted into electrical signals by the photo detectors D1, D2, and D3 via the fifth waveguides 35.

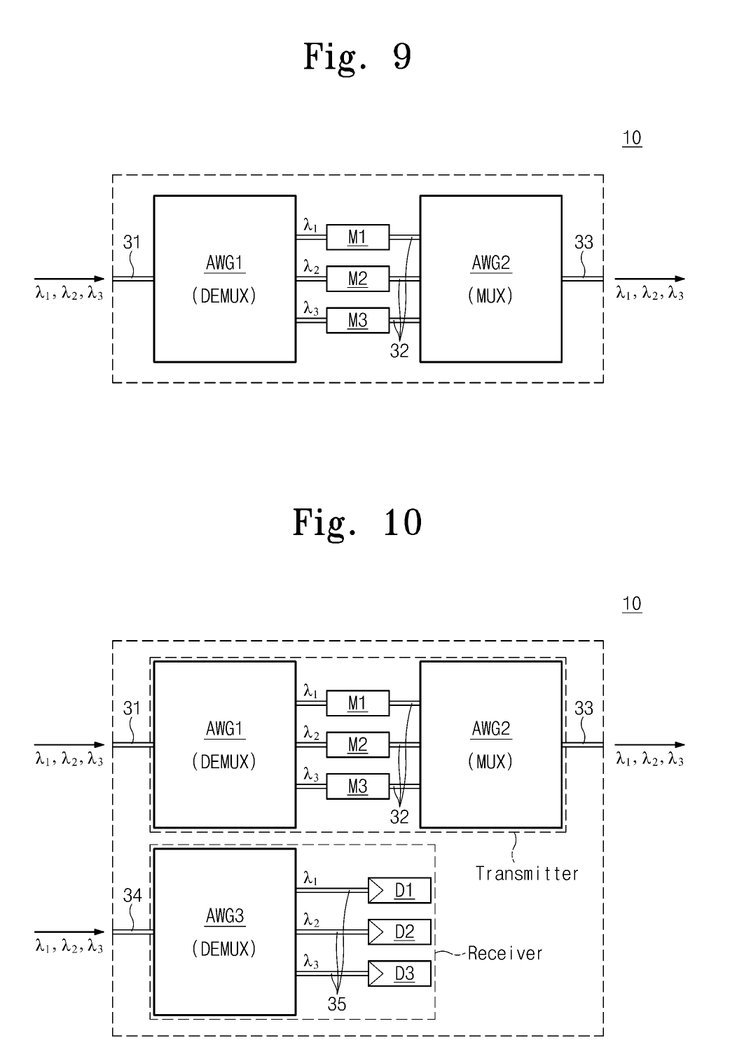

After photonics devices having the above-described technical characteristics are formed on a 5-inch silicon wafer, inventors performed an experiment for measuring the characteristics. Hereinafter, the experiment results will be described with reference to FIGS. 11 to 15.

FIG. 11 is a view illustrating positions of photonics devices integrated on a 5-inch silicon wafer.

Referring to FIG. 11, eighty-eight photonics devices integrated on a wafer. Each of the photonics devices 10 manufactured in a size of 10 mm by 10 mm and included three AWGs in which the same design rule is applied to each of the AWGs. The AWGs have the technical characteristics described with reference to FIGS. 2 and 3. Also, each of the arrayed waveguide gratings had eight output waveguides, and a wavelength spacing between the optical signals focused on each of the output waveguides was designed with 3.2 nm.

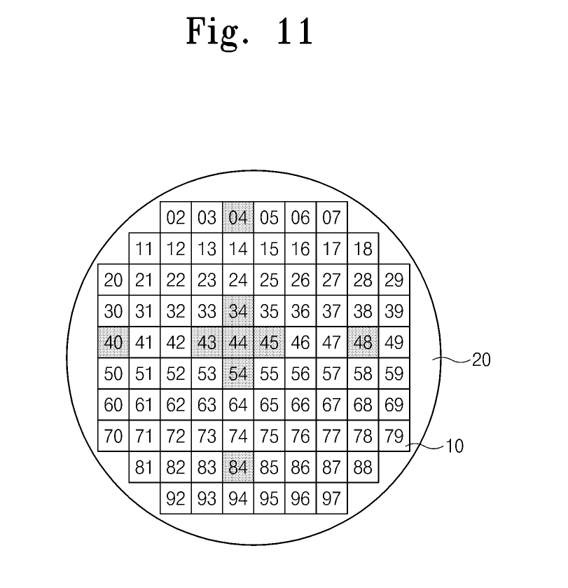

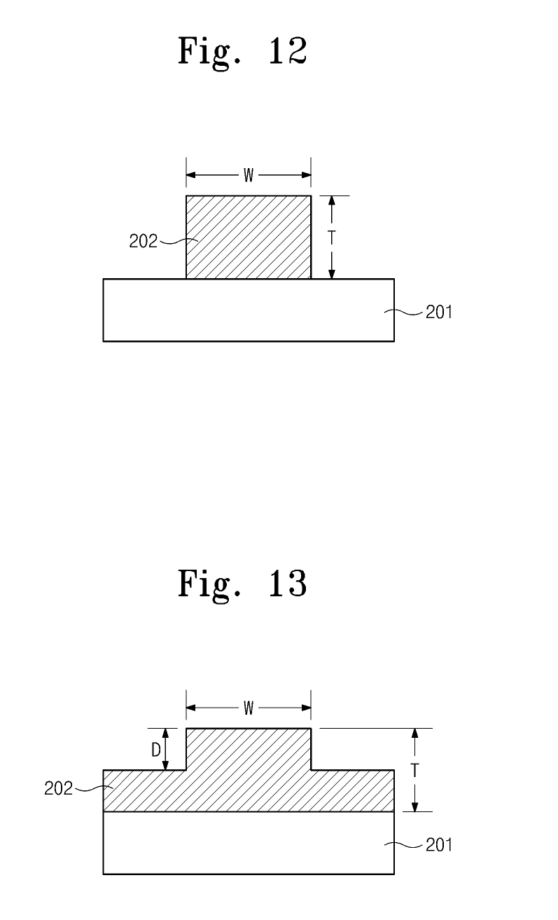

FIGS. 12 and 13 are cross-sectional views illustrating waveguide structures of an arrayed waveguide structure constituting photonics devices. More specifically, FIGS. 12 and 13 are cross-sectional views illustrating the bending section 11 and the approximately linear section 112 of the arrayed waveguide described with reference to FIG. 2.

Referring to FIGS. 12 and 13, the waveguide core layer 202 was formed of a silicon monocrystal film having a thickness of about 220 nm in all of the bending section 11 and the approximately linear section 112. In addition, the waveguide core had widths W of about 500 nm and about 1500 nm in the bending section 111 and the approximately linear section 112, respectively.

As shown in FIG. 12, the silicon core layer 202 is patterned to expose the lower clad 201 therearound in the bending section 111. As a result, as described above, the arrayed waveguide of the bending section 111 has a high confinement factor in a horizontal direction in the bending section 111. On the other hand, as shown in FIG. 13, the silicon core layer 202 has a height difference between the waveguide core and therearound in the approximately linear section 112. That is, an etching depth D of the silicon monocrystal film was less than a thickness T thereof around the waveguide core. According to the experiment results by the inventors, the etching depth D is 70 nm. As a result, the arrayed waveguide has a low confinement factor in the approximately linear section 112 in a horizontal direction.

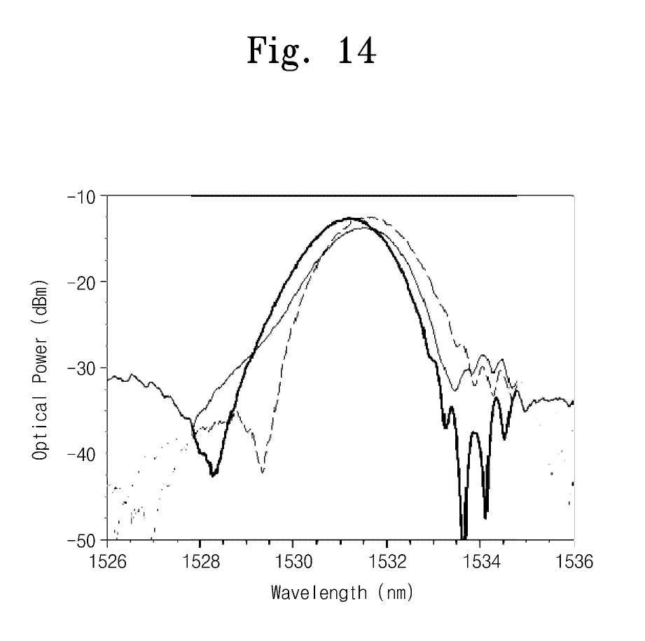

FIG. 14 is a graph illustrating deviation characteristics of center wavelengths in a photonics device according to the present invention, and FIG. 14 illustrates a wavelength spectrum measured from a photonics device disposed at a position “04” shown in FIG. 11. Specifically, three curves shown in FIG. 14 illustrate spectrums measured from output waveguides No. 1 of three arrayed waveguide structures constituting a photonics device No. “04”.

Referring to FIG. 14, a difference between wavelengths (i.e., center wavelengths) corresponding to a maximum optical power of each of spectrums was maximally 0.42 nm. Thus, in case of a photonics device applied to the present invention, it can know that uniformity of the center wavelength within the photonics device can be secured.

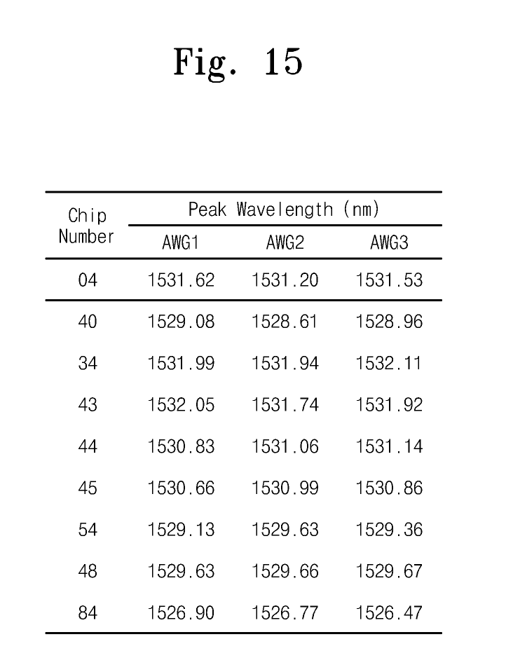

FIG. 15 is a table illustrating deviation characteristics of center wavelengths in photonics devices according to the present invention. Numbers of FIG. 15 express positions of nine photonics devices shown in FIG. 11. Peak wavelengths denote results measured from output waveguides No. 1 of three arrayed waveguide gratings disposed in each of the photonics devices.

Referring to FIG. 15, deviations of center wavelengths of the nine photonics devices are maximally 0.83 nm. Specifically, in case of eight photonics devices except a photonics device No. 34, all of the deviations of center wavelengths are less than 0.50 nm. According to the results, center wavelength deviation characteristics of the photonics devices according to the present invention described with reference to FIG. 14 can be achieved irrelevant to the positions on the wafer.

According to the present invention, each of the sections having the large curvature radius of the arrayed waveguides has the low confinement factor. Thus, the phase error according to the widths of the arrayed waveguides can be reduced. As a result, the arrayed waveguide grating structure having the improved crosstalk can be manufactured.

Also, each of the sections having the small curvature radius of the arrayed waveguides has the high confinement factor. Thus, the proceeding path of the optical signal can be guided without having the intensity loss of the optical signal. As a result, the arrayed waveguide grating structure according to the present invention can have a reduced occupation area.

In addition, the sections having the small curvature radius have the same structure irrelevant to the positions of the arrayed waveguides. As a result, the arrayed waveguide grating according to the present invention does not have an effect on the curvature radius of each of the arrayed waveguides, and the phase difference between the arrayed waveguides can be effectively controlled.

Only a portion of the sections of the waveguides generating the optical path difference between the arrayed waveguides has the low confinement factor. Thus, the optical path length error due to imperfection (specifically, the process deviation in the etching process) of the waveguide formation process can be reduced. As a result, the center wavelength difference between the plurality of arrayed waveguide grating structures integrated within the same photonics device can be significantly reduced.

In addition, in case where the optical path length error is low, since the phase error of each of the arrayed waveguides themselves is low also, the crosstalk between the wavelength-multiplexed or wavelength-demultiplexed optical signals can significantly improve in the photonics devices according to the present invention.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A photonics device comprising:
at least two arrayed waveguide grating structures,
wherein each of the arrayed waveguide grating structures comprises an input star coupler, an output star coupler, and a plurality of arrayed waveguides optically connecting the input star coupler to the output star coupler,
wherein each of the arrayed waveguides comprises at least one first section having a high confinement factor and at least two second sections having a low confinement factor, and the first sections of the arrayed waveguides have the same structure.

2. The photonics device of claim 1, wherein the arrayed waveguide grating structures comprise a first arrayed waveguide grating structure used as a wavelength division demultiplexing device and a second arrayed waveguide grating structure used as a wavelength division multiplexing device, and the photonics device further comprises first waveguides connecting the first arrayed waveguide grating structure to the second arrayed waveguide grating structure and optical modulators respectively disposed on the first waveguides.

3. The photonics device of claim 2, wherein the first and second arrayed waveguide grating structures constitute an optical transmitter in a wavelength division multiplexing scheme.

4. The photonics device of claim 2, wherein the arrayed waveguide grating structures further comprise a third arrayed waveguide grating structure, and the photonics device further comprises a plurality of photo detectors converting optical signals outputted from the third arrayed waveguide grating structure into electrical signals.

5. The photonics device of claim 4, wherein the third arrayed waveguide grating structure splits incident optical signals into the photo detectors according to their wavelengths.

6. The photonics device of claim 1, wherein each of the arrayed waveguides comprises:
at least two approximately linear sections; and
at least one or more bending sections having a curvature radius less than a minimum curvature radius of the approximately linear sections,
wherein the bending sections constitute the first section having the high confinement factor, and the approximately linear sections constitute the second sections having the low confinement factor.

7. The photonics device of claim 6, wherein the arrayed waveguides have lengths different from each other, the approximately linear sections of each of the arrayed waveguides have lengths different from each other, and the bending sections of each of the arrayed waveguides have the substantially same curvature radius and the substantially same length.

8. The photonics device of claim 6, wherein at least one of the approximately linear sections comprises:
at least one or more linear sections having a low confinement factor; and
smoothly curved sections having curvature radii greater than those of the bending sections, respectively,
wherein the linear sections of each of arrayed waveguides have lengths different from each other, and the smoothly curved sections have the substantially same curvature radius and lengths different from each other.

9. The photonics device of claim 8, wherein at least one of the approximately linear sections further comprises at least one or more linear sections having a high confinement factor, and the linear sections having the high confinement factor of each of the arrayed waveguides have lengths different from each other.

10. The photonics device of claim 1, wherein the first and second arrayed waveguide grating structures have the substantially same structure.
